(19) United States
(12) Patent Application Publication
(10) Pub. No.: US 2009/0039782 A1
(43) Pub. Date: Feb. 12, 2009

(54) PLASMA DISPLAY PANEL

(76) Inventors: Kyoung-Doo Kang, Suwon-si (KR); Won-Ju Yi, Suwon-si (KR); Ho-Young Ahn, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: CHRISTIE, PARKER & HALE, LLP, PO BOX 7068, PASADENA, CA, 91109-7068, US

(21) Appl. No.: 12/186,462

(22) Filed: Aug. 5, 2008

(30) Foreign Application Priority Data
Aug. 8, 2007 (KR) 10-2007-0079706

(51) Int. Cl. H01J 17/49

(52) U.S. Cl. 313/582

(57) ABSTRACT

A plasma display panel having a structure for reducing manufacturing costs and the failure rate of terminal portions of discharge electrodes. The PDP includes: a substrate and a barrier rib structure configuring a plurality of discharge cells. Discharge electrodes include discharge portions, terminal portions, and connection portions connecting the discharge portions with the terminal portions. A sealing member seals the discharge cells. A frit seals the substrate and the sealing member. At least one frit guide restricts the spreading of the frit. A phosphor layer is inside each of the discharge cells. A discharge gas is sealed in the discharge cells.

### CROSS-REFERENCE TO RELATED PATENT APPLICATION

This application claims priority to and the benefit of Korean Patent Application No. 10-2007-0079706, filed on Aug. 8, 2007, in the Korean Intellectual Property Office, the entire content of which is incorporated herein by reference.

### BACKGROUND OF THE INVENTION

1. Field of the Invention

The present invention relates to a plasma display panel (PDP) and, more particularly, to a PDP having a reduced manufacturing cost structure.

2. Description of the Related Art

PDPs, which have replaced conventional cathode ray tube (CRT) display devices, display desired images using visible rays generated by sealing discharge gas and applying a discharge voltage between two substrates on which electrodes are formed to generate vacuum ultraviolet rays. The vacuum ultraviolet rays interact with phosphors in discharge cells to display the desired images.

A conventional PDP is manufactured by disposing discharge electrodes, barrier ribs, and phosphor layers between a front substrate and a rear substrate, disposing a frit with a predetermined thickness on inner edges of the front substrate and the rear substrate, and injecting a discharge gas into the PDP.

However, the conventional PDP includes the front substrate and the rear substrate, which are formed of glass having a thickness of several millimetres. The resultant glass substrates become very weighty and expensive. Therefore, PDPs which include front and rear substrates formed of glass, have increased weight and manufacturing costs.

Further, the frit of the conventional PDP that is disposed on edges of the front and rear substrates can cover terminal portions of discharge electrodes when sealing the PDP. The frit often causes the failure rate of terminal portions when terminal portions of discharge electrodes are formed.

### SUMMARY OF THE INVENTION

In accordance with the present invention a PDP is provided having a structure for reducing both manufacturing costs and the failure rate of terminal portions of discharge electrodes.

According to an exemplary embodiment of the present invention, a PDP includes a substrate and a barrier rib structure configuring a plurality of discharge cells. Discharge electrodes include discharge portions arranged inside the barrier rib structure for performing a discharge, terminal portions arranged on the substrate, and connection portions connecting the discharge portions with the terminal portions. A sealing member seals the discharge cells. A frit is disposed between the substrate and the sealing member and seals the substrate and the sealing member. At least one frit guide is disposed between the substrate and the sealing member and restricts the spreading of the frit. Phosphor layers are disposed inside the discharge cells. A discharge gas is sealed in the discharge cells.

According to another exemplary embodiment of the present invention a PDP includes a substrate and a barrier rib structure configuring a plurality of discharge cells. Discharge electrodes include discharge portions arranged inside the barrier rib structure for performing a discharge, terminal portions arranged on the substrate, and connection portions connecting the discharge portions with the terminal portions. A sealing member seals the discharge cells. A frit is disposed between the substrate and the sealing member and seals the substrate and the sealing member. At least one sealing member groove is formed on the sealing member and restricts the spreading of the frit. Phosphor layers are disposed inside the discharge cells. A discharge gas is sealed in the discharge cells.

Protective layers may cover at least a portion of sidewalls of the barrier rib structure.

The discharge portions may surround at least a portion of each of the discharge cells.

The discharge portions may include a stripe-shaped portion coupled to a discharge cell surrounding portion.

Conductive wires of a signal transmitting member may be connected to the terminal portions.

The sealing member may be formed of a dielectric substance.

A substance forming the sealing member may be the same as that of the barrier rib structure.

The sealing member and the barrier rib structure may be integrally formed.

The frit guide may be formed of a dielectric substance.

A substance forming the frit guide may be the same as that of the sealing member.

The frit guide and the sealing member may be integrally formed.

The sealing member grooves may be stripe-shaped.

The sealing member grooves may be spaced apart from each other and discontinuously formed.

The phosphor layers may be formed by forming phosphor grooves on the substrate and disposing phosphors on the phosphor grooves.

### BRIEF DESCRIPTION OF THE DRAWINGS

FIG. 1 is a partially exploded perspective view of a PDP according to an embodiment of the present invention.

FIG. 2 is a cross-sectional view of the PDP of FIG. 1 taken along a line II-II in FIG. 1.

FIG. 3 is a cross-sectional view of the PDP of FIG. 1 taken along a line III-III in FIG. 2.

FIG. 4 is a cross-sectional view of a PDP according to another embodiment of the present invention.

FIG. 5 is a partially exploded perspective view of a PDP according to another embodiment of the present invention.

FIG. 6 is a cross-sectional view of the PDP of FIG. 5 taken along a line VI-VI in FIG. 5.

FIG. 7 is a cross-sectional view of the PDP of FIG. 5 taken along a line VII-VII in FIG. 6.

### DETAILED DESCRIPTION

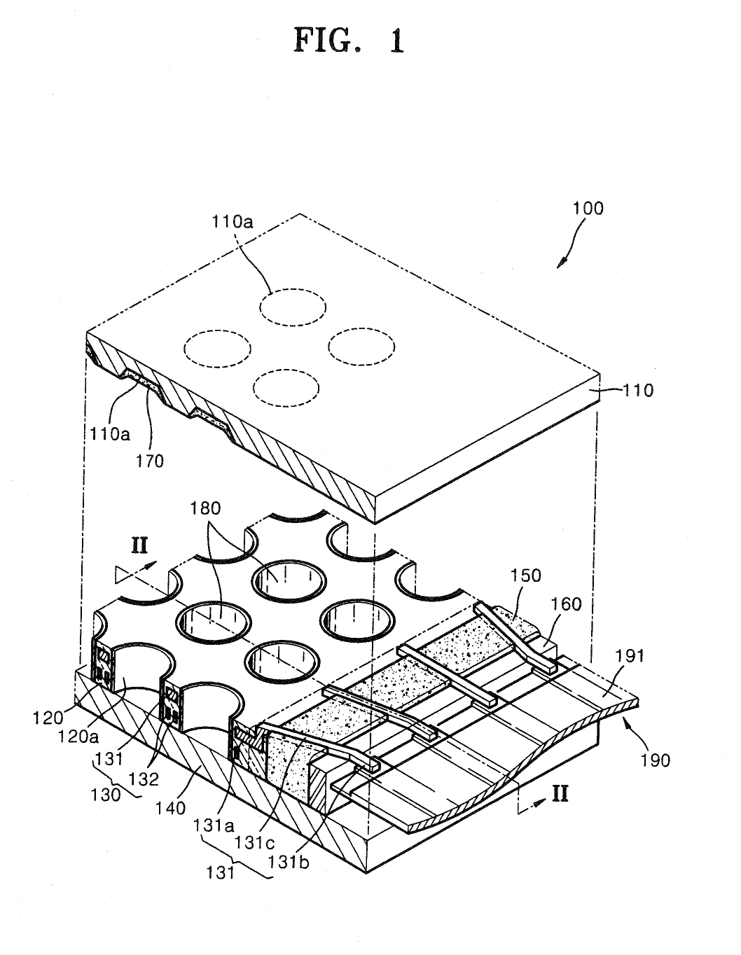

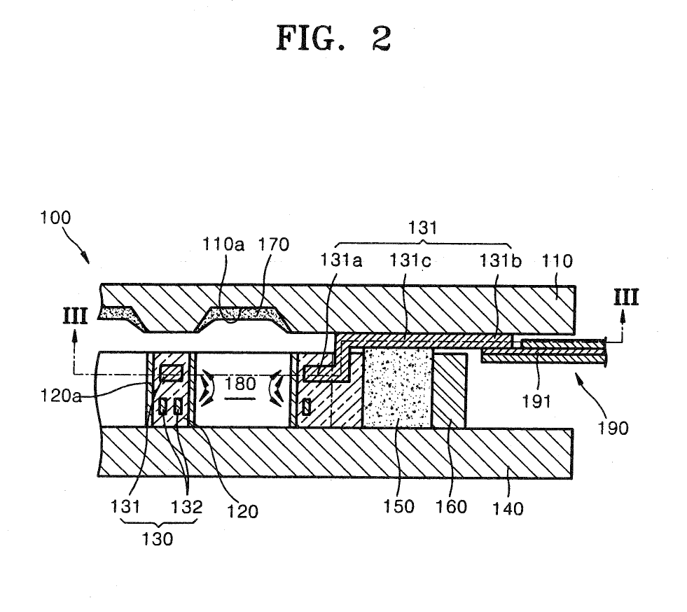

Referring to FIGS. 1 and 2, the PDP 100 includes a substrate 110, a barrier rib structure 120, a plurality of discharge electrodes 130, a sealing member 140, a frit 150, a frit guide 160, and phosphor layers 170.

The substrate 110 is transparent and formed of glass through which visible light passes.

In the present embodiment, since the substrate 110 is transparent but the present invention is not necessarily restricted thereto. In more detail, the substrates 110 may be formed of a translucent material and include a color filter.

The barrier rib structure 120 configures discharge cells 180 in which a discharge is generated.

In the present embodiment, the barrier rib structure 120 configure the discharge cells 180 in which the phosphor layers 170 are arranged and thus, define display regions in which an image is to be displayed, but the present invention is not necessarily limited thereto. In more detail, the barrier rib structure 120 may partition dummy cells where the image is not displayed. Dummy cells do not include electrodes or phosphor layers and thus do not perform a discharge. In this case, the dummy cells can be formed on edges of the substrate 110 and between the discharge cells 180.

In the present embodiment, the discharge cells 180 configured by the barrier rib structure 120 have circular cross-sections, but are not necessarily restricted thereto, and can have other cross-sectional shapes such as triangular, tetragonal, octagonal, etc. or oval cross sections.

A dielectric substance forming the barrier rib structure 120 prevents conduction between the discharge electrodes 130 when a sustain discharge is generated, and prevents the discharge electrodes 130 from being damaged due to collisions between charge particles and the discharge electrodes 130, thereby accumulating wall charges by inducing the charge particles. The dielectric substance may be lead oxide (PbO), diboron trioxide (B₂O₃), silicon dioxide (SiO₂), etc.

Protective layers 120a cover sides of the barrier rib structure 120 that surround the discharge cells 180. The protective layers 120a that may be formed of magnesium oxide (MgO) prevent the discharge electrodes 130 and the barrier rib structure 120 formed of the dielectric substance from being damaged due to sputtering of plasma particles, discharge secondary electrons, and reduce the discharge voltage.

The discharge electrodes 130 include first discharge electrodes 131 and second discharge electrodes 132 spaced apart from each other.

The first discharge electrodes 131 include discharge portions 131a, terminal portions 131b, and connection portions 131c. The first discharge electrodes 131 will now be described in more detail.

The discharge portions 131 a are disposed inside the barrier rib structure 120 to perform a discharge.

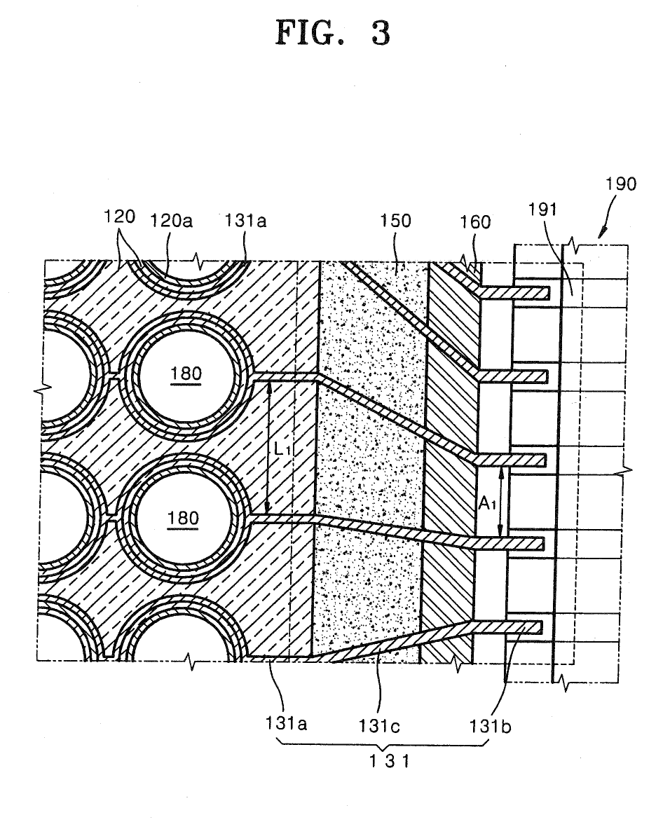

The terminal portions 131b are arranged on the upper surface of the substrate 110 to be connected to conductive wires 191 of a signal transmitting member 190. As seen in FIG. 3, distance A₁ between the terminal portions 131b is smaller than a distance L₁ between the discharge portions 131a in order to facilitate the connection between the terminal portions 131b and the signal transmitting member 190.

The connection portions 131c electrically connect the discharge portions 131a to the terminal portions 131b. Some portions of the connection portions 131c closer to the discharge portions 131a are buried in the barrier rib structure 120. Other portions of the connection portions 131c disposed outside the barrier rib structure 120 are arranged on the upper surface of the substrate 110.

In the present embodiment, some portions of the connection portions 131c closer to the discharge portions 131a are buried in the barrier rib structure 120, and other portions of the connection portions 131c disposed outside the barrier rib structure 120 are arranged on the upper surface of the substrate 110, but the present invention is not necessarily limited thereto. That is, there is no particular restriction to the arrangement of the connection portions 131c as long as the connection portions 131c can electrically connect the discharge portions 131a to the terminal portions 131b.

Since the second discharge electrodes 132 cross the first discharge electrodes 131 and are symmetrical to each other, the second discharge electrodes 132, like the first discharge electrodes 131, include discharge portions (not shown), terminal portions (not shown), and connection portions (not shown), and their detailed structure is identical to that of the first discharge electrodes 131.

In the present embodiment, the first discharge electrodes 131 perform an addressing function since the first discharge electrodes 131 and the second discharge electrodes 132 cross each other but are not necessarily restricted thereto. In more detail, the PDP of the present invention includes electrodes that perform the addressing function, that is, the PDP of the present invention is a 3D type PDP.

In the present embodiment, the discharge portions 131a of the first discharge electrodes 131 and the discharge portions of the second discharge electrodes 132 surround the discharge cells 180 so that a sustain discharge is generated in a perpendicular direction at every perimeter position of the discharge portions 131a configuring the discharge cells 180, but are not necessarily restricted thereto. In more detail, the first and second discharge electrodes 131, 132 may include a stripe-shaped portion coupled to a discharge cell surrounding portion and buried in the barrier rib structure 120. In this case, the first and second discharge electrodes 131, 132 have a discharge path of opposite discharge rather than a surface discharge.

Referring to FIG. 3, in the present embodiment, the discharge portions 131a of the first discharge electrodes 131 and the discharge portions of the second discharge electrodes 132 are in the shape of a circular ring but are not necessarily restricted thereto. The discharge portions 131a of the first discharge electrodes 131 and the discharge portions of the second discharge electrodes 132 can be in the shape of an oval ring and a polygonal ring such as a triangle, a pentagon, etc, or a C character.

In the present embodiment, since the discharge portions 131a of the first discharge electrodes 131 and the discharge portions of the second discharge electrodes 132 are arranged inside the barrier rib structure 120, the first discharge electrodes 131 and the second discharge electrodes 132 do not need to be transparent electrodes, and can be formed of a conductive and anti-resistant metal such as gold (Ag), aluminum (Al), copper (Cu), etc., such that the PDP 100 can quickly respond to a discharge, does not distort a signal, and reduces power consumption required for the sustain discharge.

The sealing member 140 is disposed on lower portion of the barrier rib structure 120 to seal the discharge cells 180. The sealing member 140 may be formed integrally with the lower portion of the barrier rib structure 120.

The sealing member 140 can be formed of various materials and may be formed of a dielectric substance. The dielectric substance forming the sealing member 140 may be the same as that of the barrier rib structure 120 or different from that of the barrier rib structure 120. In more detail, the sealing member 140 is formed of a material that is lighter and cheaper than the glass forming substrates of a conventional PDP.

The frit 150 is disposed between the substrate 110 and the sealing member 140 to seal the substrate 110 and the sealing member 140.

The frit 150 is disposed on edges of the PDP 100, i.e., outside the barrier rib structure 120, to seal the substrate 110 and the sealing member 140, thereby sealing the discharge cells 180.

The frit guide 160 is formed on the sealing member 140, corresponds to the barrier rib structure 120, and faces the frit 150.

The frit guide 160 is formed integrally with the sealing member 140 but the present invention is not limited thereto. In more detail, the frit guide 160 of the present embodiment does not have any particular restriction as to its location, only that the frit guide 160 be able to restrict the spreading of the frit 150.

The frit guide 160 of the present embodiment may be formed of a dielectric substance which is the same as that of the sealing member 140 but the present invention is not limited thereto. In more detail, the frit guide 160 of the present embodiment does not have any particular restriction as to its material. The frit guide 160 may be formed of synthetic resin if the frit guide 160 has electrical insulation properties since the frit guide 160 is disposed to contact the discharge electrodes 130.

The frit guide 160 prevents the frit 150 from spreading toward the terminal portions 131b of the discharge electrodes 130 during a sealing process. In more detail, the frit 150 is pressed during the sealing process and thus spreads between the substrate 110 and the sealing member 140 and between the barrier rib structure 120 and the frit guide 160.

The frit guide 160 is spaced apart from the barrier rib structure 120 by a predetermined distance in order to more effectively prevent the frit 150 from spreading toward the terminal portions 131b of the discharge electrodes 130. The predetermined distance is properly determined based on the amount of the frit 150 to be disposed.

In the present embodiment, the PDP 100 includes the single frit guide 160 on each edge thereof but the present invention is not limited thereto. That is, the PDP 100 of the present embodiment can include a plurality of frit guides on each edge thereof.

The frit guide 160 of the present embodiment is stripe-shaped, is continuously formed, and has a rectangular cross-section, but the present invention is not limited thereto. In more detail, the frit guide 160 of the present embodiment is disposed between the sealing member 140 and the terminal portions 131b of the discharge electrodes 130. In this direction, the frit guide 160 is discontinuously formed.

The frit guide 160 of the present embodiment does not have any particular restriction as to its cross-section shape and width. For example, the frit guide 160 of the present embodiment can have a stepped cross-section shape.

The phosphor layers 170 are disposed in phosphor grooves 110a formed on the substrate 110 and include red, green, and blue discharge cells 180. The phosphor grooves 110a are formed in the substrate 110 where the discharge cells 180 are formed, by sandblasting, etching, or the like.

The phosphor layers 170 have a component generating visible light with ultraviolet rays. That is, a phosphor layer formed in a red light emitting discharge cell has a phosphor such as Y(V,P)O₄:Eu, a phosphor layer formed in a green light emitting discharge cell has a phosphor such as Zn₂SiO₄:Mn, YBO₃:Tb, and a phosphor layer formed in a blue light emitting discharge cell has a phosphor such as BAM:Eu.

The phosphor layers 170 of the present embodiment are formed by forming the phosphor grooves 110a in the substrate 110 and coating phosphor in the phosphor grooves 110a but are not necessarily restricted thereto. In more detail, the phosphor layers 170 can be formed in any portions of the discharge cells 180 such as sidewalls of the barrier rib structure 120, in order to discharge visible light using ultra violet rays generated by a plasma discharge.

After the substrate 110 and the sealing member 140 are sealed by the frit 150, a discharge gas such as neon (Ne), Xenon (Xe), or a mixture thereof is filled in the PDP 100.

When the PDP 100 is assembled and then a plasma display module is manufactured, the conductive wires 191 of the signal transmitting member 190 are electrically connected to the terminal portions 131b of the discharge electrodes 130, respectively.

The signal transmitting member 190 is electrically connected to an operating circuit substrate (not shown) that operates the PDP 100, and is formed of a flexible printed cable (FPC) or a tape carrier package (TCP).

The signal transmitting member 190 is formed of the conductive wires 191 that transfer an electrical signal. The conductive wires 191 are electrically connected to the terminal portions 131b of the discharge electrodes 130. The conductive wires 191 of the signal transmitting member 190 are connected to the terminal portions 131b of the discharge electrodes 130 using an anisotropic conductive film.

A manufacturing method and functions of the PDP 100 according to the present embodiment will now be described in more detail.

The manufacturing operations of the PDP 100 include forming the phosphor layers 170, forming the barrier rib structure 120, forming the frit guide 160, assembling and sealing the PDP 100, and injecting a discharge gas.

A method of forming the phosphor layers 170 will now be described.

The phosphor grooves 1 1a are formed on the substrate 110 where the discharge cells 180 are disposed using a glass cutting method such as sand blasting, etching, etc., and phosphor is coated in the phosphor grooves 110a to form the respective phosphor layers 170.

Some portions of the terminal portions 131b and the connection portions 131c of the discharge electrodes 130 are formed on the substrate 110.

A method of forming the barrier rib structure 120 will now be described.

The first and second discharge electrodes 131,132 are buried, dielectric sheets are stacked, and punches in which the discharge cells 180 are to be formed are formed in the dielectric sheets to form the barrier rib structure 120.

After the barrier rib structure 120 is formed, the protective layers 120a formed of MgO are disposed on sidewalls of the barrier rib structure 120 using vacuum deposition.

The frit guide 160 is formed on edges of the sealing member 140 using screen printing, etc. As described above, the frit guide 160 is spaced apart from the barrier rib structure 120 by a predetermined distance based on the amount of the frit 150 to be disposed.

Thereafter, the barrier rib structure 120 is adhered on the sealing member 140 and is integrally attached to the sealing member 140.

The sealing member 140 to which the barrier rib structure 120 is attached and the substrate 110 are assembled and sealed. During this process, the frit 150 is disposed between the barrier rib structure 120 and the frit guide 160 so that portions of the connection portions 131c of the discharge electrodes 130 that are disposed on the substrate 110 and other portions thereof that are exposed to the barrier rib structure 120 are electrically connected to each other.

During the assembling and sealing process, both ends of the substrate 110 and the sealing member 140 are heated and pressed so that the frit 150 spreads between the substrate 110 and the sealing member 140. In this regard, the frit guide 160 prevents the frit 150 from spreading toward the terminal portions 131b of the discharge electrodes 130 in order to prevent the frit 150 from entering into the terminal portions 131b of the discharge electrodes 130, which reduces the failure rate of the terminal portions 131b, thereby facilitating the connection between the terminal portions 131b of the discharge electrodes 130 and the signal transmitting member 190.

After sealing the PDP 100, vacuum is exhausted from the PDP 100 and the discharge gas is injected into the PDP 100.

After injecting the discharge gas, the terminal portions 131b are connected to the conductive wires 191 of the signal transmitting member 190 using an anisotropic conductive film.

The operation of the PDP 100 will now be described in more detail.

After the manufacturing of the PDP 100 and the injection of the discharge gas are complete, if an address voltage is applied between the first discharge electrodes 131 and the second discharge electrodes 132 from an external power source, an address discharge is generated. Thus, a discharge cell where a sustain discharge is to be generated is selected from the discharge cells 180.

If a discharge sustain voltage is applied between first discharge electrodes 131 and the second discharge electrodes 132 of the selected discharge cell 180, the sustain discharge is generated due to movement of wall charges accumulated in the barrier rib structure 120 by the first discharge electrodes 131 and the second discharge electrodes 132. The energy level of the discharge gas excited by the sustain discharge is reduced, thereby discharging ultraviolet rays.

The ultraviolet rays excite the phosphor layers 170 in the discharge cells 180. The energy level of the excited phosphor layers 170 is reduced to emit visible light. The emitted visible light passes through the substrate 110 and forms an image to be recognized by a user.

Therefore, the PDP 100 of the present embodiment does not include a rear substrate, which reduces the whole weight and manufacturing costs of the PDP 100.

In the present embodiment, the barrier rib structure 120 and the sealing member 140 of the PDP 100 can be integrally formed, thereby reducing whole manufacturing processes and reducing manufacturing costs.

The PDP 100 of the present embodiment includes the frit guide 160 disposed on the sealing member 140, which prevents the frit 150 from penetrating into the terminal portions 131b of the discharge electrodes 130. Thus the quality of the PDP 100 is improved, and the failure rate of the terminal portions 131b is reduced, thereby reducing manufacturing costs.

The PDP 100 of the present embodiment can form the barrier rib structure 120 having discharge spaces by stacking sheets and forming cylindrical grooves in the sheets, thereby reducing manufacturing processes and manufacturing costs.

The first discharge electrodes 131 and the second discharge electrodes 132 surround the discharge cells 180 so that the sustain discharge is performed at every perimeter position of the discharge cells 180. Therefore, the PDP 100 of the present embodiment has a relatively wide discharge area, thereby increasing light-emitting brightness and light emitting efficiency.

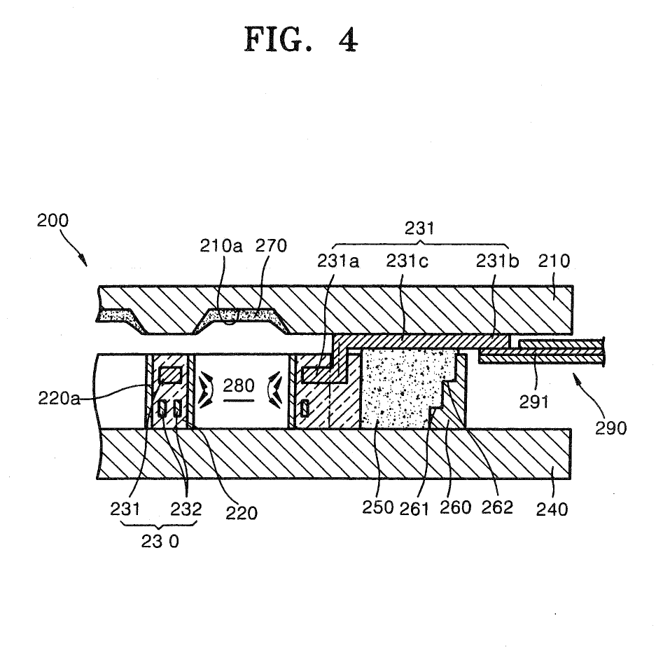

FIG. 4 is a cross-sectional view of the PDP 200 according to another embodiment of the present invention. Differences between the PDP 100 illustrated in FIG. 1 and a PDP illustrated in FIG. 4 will now be described.

Referring to FIG. 4, the PDP 200 includes a substrate 210, a barrier rib structure 220, protective layers 220a, a plurality of discharge electrodes 230, a sealing member 240, a frit 250, a frit guide 260, phosphor layers 270, and discharge cells 280.

Phosphor grooves 210a in which the phosphor layers 270 are disposed are formed on the substrate 210. The discharge electrodes 230 include first discharge electrodes 231 and second discharge electrodes 232. The first discharge electrodes 231 include discharge portions 231a, terminal portions 231b, and connection portions 231c. The second discharge electrodes 232 are symmetrical to each other and their detailed structure is identical to that of the first discharge electrodes 231.

The terminal portions 231b of the first discharge electrodes 231 are electrically connected to conductive wires 291 of a signal transmitting member 290. Terminal portions of the second discharge electrodes 232 are electrically connected to the signal transmitting member 290.

The frit guide 260 includes a first step 261 and a second step 262, which can contain more of the amount of the frit 250 disposed in assembling the PDP 200, thereby better preventing the frit 250 from spreading toward the terminal portions 231b.

In more detail, in the present embodiment, the first step 261 and the second step 262 are included in the frit guide 260, thereby more reliably protecting the failure rate of the terminal portions of the discharge electrodes 230.

Besides the constitution, operation, and effect of the PDP 200, the other constitution, operation, and effect of the PDP 200 of the present embodiment are identical to those of the PDP 100 illustrated in FIG. 1, and thus their descriptions are not repeated.

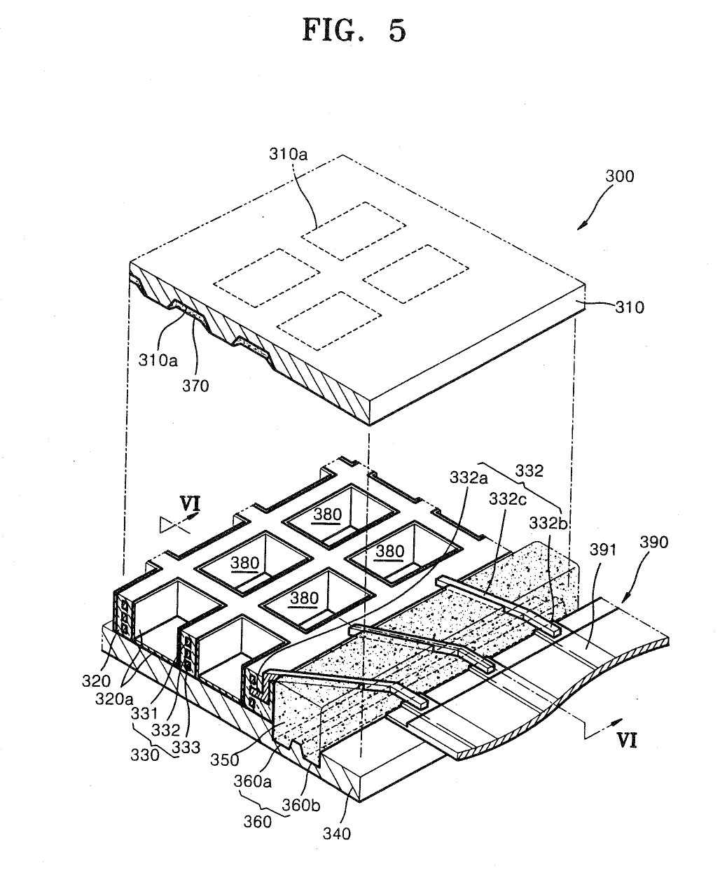

Another embodiment of the present invention will now be described with reference to FIGS. 5 through 7.

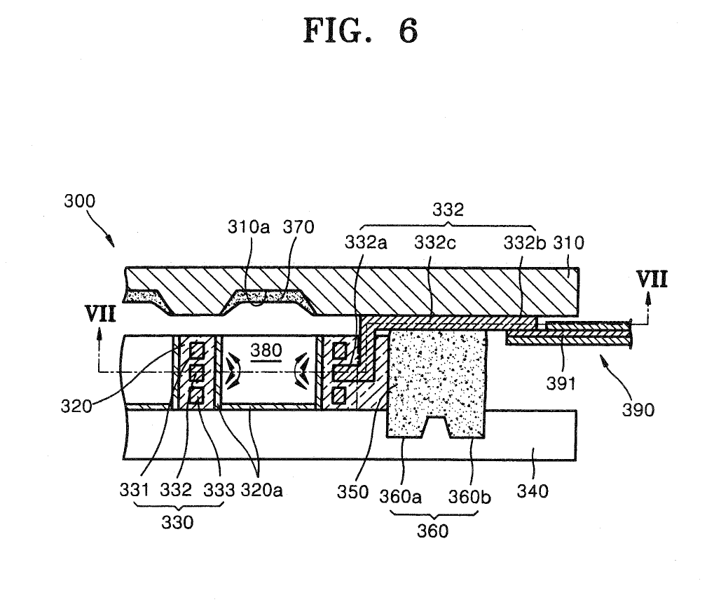

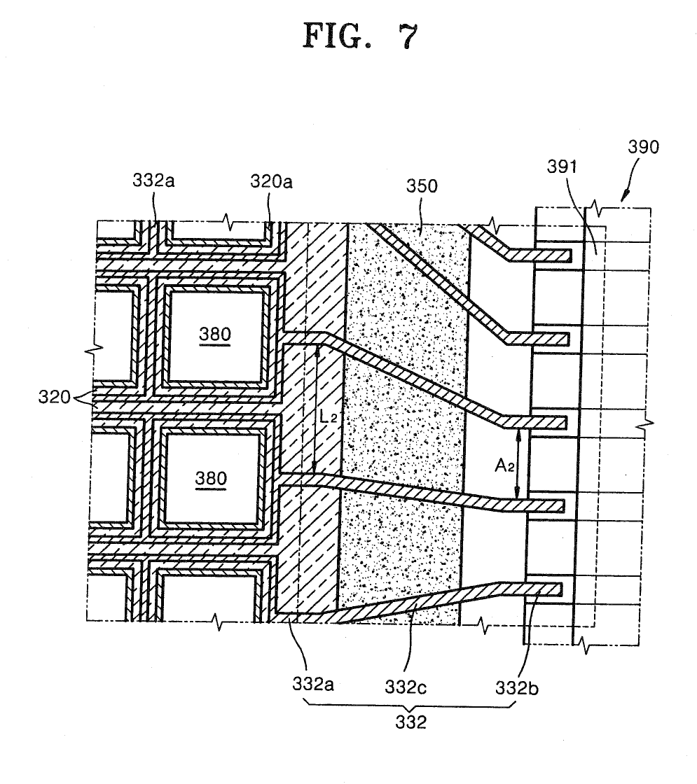

FIG. 5 is a partially exploded perspective view of a PDP 300 according to another embodiment of the present invention. FIG. 6 is a cross-sectional view of the PDP of FIG. 5 taken along a line VI-VI in FIG. 5. FIG. 7 is a cross-sectional view of the PDP of FIG. 5 taken along a line VII-VII in FIG. 6.

Referring to FIGS. 5 and 6, the PDP 300 includes a substrate 310, a barrier rib structure 320, a plurality of discharge electrodes 330, a sealing member 340, a frit 350, sealing member grooves 360, and phosphor layers 370.

The substrate 310 is transparent and formed of glass through which visible light passes.

The barrier rib structure 320 configures discharge cells 380 in which a discharge is generated. The discharge cells 380 configured by the barrier rib structure 320 have tetragonal cross-sections.

A dielectric substance forming the barrier rib structure 320 prevents conduction between the discharge electrodes 330 when a sustain discharge is generated, and prevents the discharge electrodes 330 from being damaged due to collisions between charge particles and the discharge electrodes 330, thereby accumulating wall charges by inducing the charge particles. The dielectric substance may be PbO, B₂O₃, SiO₂, etc.

Protective layers 320a that are formed of MgO cover sides of the barrier rib structure 320 and upper surface of the sealing member 340 disposed on the discharge cells 380.

The discharge electrodes 330 include first discharge electrodes 331, second discharge electrodes 332 spaced apart from the first discharge electrodes 331, and third discharge electrodes 333 spaced apart from the second discharge electrodes 332.

The first discharge electrodes 331 and the third discharge electrodes 333 extend parallel to each other. The second discharge electrodes 332 extend across the first discharge electrodes 331 and the third discharge electrodes 333. The second discharge electrodes 332 serve as address electrodes that perform an addressing function.

The present invention is not necessarily limited to the arrangement structure of the first discharge electrodes 331, the second discharge electrodes 332, and the third discharge electrodes 333 in the present embodiment. That is, two of the first discharge electrodes 331, the second discharge electrodes 332, and the third discharge electrodes 333 can extend parallel to each other, and the other can extend across the two discharge electrodes. In this case, one of the two discharge electrodes serves as scan electrodes, the other of the two discharge electrodes serves as common electrodes, and the other discharge electrodes extending across the two discharge electrodes serves as address electrodes.

The discharge electrodes 330 include discharge portions, terminal portions, and connection portions. The second discharge electrodes 332 will now be described in more detail.

Discharge portions 332a of the second discharge electrodes 332 are disposed inside the barrier rib structure 320 to perform a discharge.

Terminal portions 332b are arranged on the upper surface of the substrate 310 to be connected to conductive wires 391 of a signal transmitting member 390. As shown in FIG. 7, an interval A₂ between the terminal portions 332b is smaller than that interval L₂ between the discharge portions 332a in order to facilitate the connection between the terminal portions 332b and the signal transmitting member 390.

Connection portions 332c electrically connect the discharge portions 332a to the terminal portions 332b. Some portions of the connection portions 332c closer to the discharge portions 332a are buried in the barrier rib structure 320. Other portions of the connection portions 332c disposed outside the barrier rib structure 320 are arranged on the upper surface of the substrate 310.

Since the first discharge electrodes 331 and the third discharge electrodes 333 cross the second discharge electrodes 332 and are symmetrical to one another, the first discharge electrodes 331 and the third discharge electrodes 333, like the second discharge electrodes 332, include discharge portions (not shown), terminal portions (not shown), and connection portions (not shown), and their detailed structure is identical to that of the second discharge electrodes 332.

In the present embodiment, the discharge portions of the first discharge electrodes 331, the discharge portions 332a of the second discharge electrodes 332, and the discharge portions of the third discharge electrodes 333 surround the discharge cells 380. Referring to FIG. 7, the discharge portions of the first discharge electrodes 331, the second discharge electrodes 332, and the third discharge electrodes 333 have trapezoid cross-sections.

However, the first discharge electrodes 331, the second discharge electrodes 332, and the third discharge electrodes 333 may include a stripe-shaped portion coupled to a discharge cell surrounding portion and be buried in the barrier rib structure 320.

The discharge portions of the first discharge electrodes 331, the second discharge electrodes 332, and the third discharge electrodes 333 are in the shape of a circular ring, an oval ring, and a polygonal ring such as a triangle, a pentagon, etc, or a C character.

In the present embodiment, since the discharge portions of the first discharge electrodes 331, the discharge portions 332a of the second discharge electrodes 332, and the discharge portions of the third discharge electrodes 333 are arranged inside the barrier rib structure 320, the first discharge electrodes 331, the second discharge electrodes 332, and the third discharge electrodes 333 can be formed of a conductive and anti-resistant metal such as Ag, Al, Cu, etc.

The sealing member 340 is disposed on lower portion of the barrier rib structure 320 to seal the discharge cells 380. The sealing member 340 may be formed integrally with the lower portion of the barrier rib structure 320.

The frit 350 is disposed between the substrate 310 and the sealing member 340 to seal the substrate 310 and the sealing member 340.

The frit 350 is disposed on edges of the PDP 300, i.e., outside the barrier rib structure 320, to seal the substrate 310 and the sealing member 340, thereby sealing the discharge cells 380.

The sealing member grooves 360 are formed on the sealing member 140 where the frit 350 is to be disposed, is stripe-shaped, and is continuously formed.

The sealing member grooves 360 prevent the frit 350 from spreading toward the terminal portions of the discharge electrodes 330 during a sealing process. In more detail, the frit 350 is pressed during the sealing process and thus spread between the substrate 310 and the sealing member 340. In this case, the sealing member grooves 360 prevent the spreading of the frit 350 toward the terminal portions 332b of the discharge electrodes 330.

The sealing member grooves 360 have proper depths and widths in order to more effectively prevent the frit 350 from spreading toward the terminal portions 332b of the discharge electrodes 330. The predetermined depths and widths are properly determined by a designer based on the amount of the frit 350 to be disposed.

In the present embodiment, the sealing member grooves 360 include first sealing member grooves 360a and second sealing member grooves 360b. Therefore, though the frit 350 melted during the sealing process is filled in the innermost first sealing member grooves 360a and spreads toward the terminal portions 332b, a considerable amount of the frit 350 is filled in the outermost second sealing member grooves 360b, thereby restricting the spread of the frit 350.

In the present embodiment, the two sealing member grooves 360 are formed on the sealing member 340 but the present invention is not limited thereto. That is, the PDP 300 of the present embodiment can include one, three, or four sealing member grooves if necessary.

The sealing member grooves 360 of the present embodiment are stripe-shaped, are continuously formed along a region where the frit 350 is disposed but the present invention is not limited thereto. In more detail, the sealing member grooves 360 of the present embodiment are spaced apart from each other and discontinuously formed. In this case, the sealing member grooves 360 have circular, oval, polygonal cross-sections or the like. The depth of the sealing member grooves 360 may be determined so that the frit 350 does not spread toward the terminal portions of the discharge electrodes 330 after the frit 350 is fully disposed.

The phosphor layers 370 are disposed in the phosphor grooves 310a formed on the substrate 310 and include red, green, and blue discharge cells 380. The phosphor grooves 310a are formed in the substrate 310 where the discharge cells 380 are formed, by sandblasting, etching, or the like.

The phosphor layers 370 have the same phosphors as those of the phosphor layers 170 illustrated in FIG. 1, and thus their descriptions will not be repeated.

After the substrate 310 and the sealing member 340 are sealed, a discharge gas such as Ne, Xe, or a mixture thereof is filled in the PDP 300.

A manufacturing method and functions of the PDP 300 according to the present embodiment will now be described in more detail.

The manufacturing operations of the PDP 300 include forming the phosphor layers 370, forming the barrier rib structure 320, forming the sealing member grooves 360, assembling and sealing the PDP 300, and injecting a discharge gas.

A method of forming the phosphor layers 370 will now be described.

The phosphor grooves 310a are formed on the substrate 310 where the discharge cells 380 are disposed using a glass cutting method such as sand blasting, etching, etc., and phosphor is disposed in the phosphor grooves 310a to form the phosphor layers 370.

Some portions of the terminal portions and the connection portions of the discharge electrodes 330 are formed on the substrate 310.

A method of forming the barrier rib structure 320 will now be described.

The first, second, and third discharge electrodes 331, 332, 333 are buried, dielectric sheets are stacked to form a sheet structure, and punches in which the discharge cells 380 are to be formed are formed in the dielectric sheets to form the barrier rib structure 320.

The sealing member grooves 360 are formed on edges of the sealing member 340 and stripe-shaped. That is, the sealing member grooves 360 are formed on the place in which the frit 350 is disposed. The sealing member grooves 360 are formed using the glass cutting method such as sand blasting, etching, etc. The width and depth of the sealing member grooves 360 are properly determined based on the amount of the frit 350 to be adhered.

Thereafter, the barrier rib structure 320 is adhered on the front surface of the sealing member 340 and is integrally attached to the sealing member 340.

Thereafter, the protective layers 320a formed of MgO are disposed on sidewalls of the barrier rib structure 320 and the front surface of the sealing member 340 where the discharge cells 380 are disposed using vacuum deposition.

The sealing member 340 to which the sealing member grooves 360 are formed and the substrate 310 are assembled and sealed. During this process, the frit 350 is disposed on outside walls of the barrier rib structure 320, i.e., the sealing member grooves 360 are formed, so that portions of the connection portions 332c of the discharge electrodes 330 that are disposed on the substrate 310 and other portions thereof that are exposed to the barrier rib structure 320 are electrically connected to each other.

During the assembling and sealing process, both ends of the substrate 310 and the sealing member 340 are heated and pressed so that the frit 350 spreads between the substrate 310 and the sealing member 340. In this regard, the sealing member grooves 360 prevent the frit 350 from spreading toward the terminal portions 332b of the discharge electrodes 330 in order to prevent the frit 350 from entering into the terminal portions 332b of the discharge electrodes 330, which reduces the failure rate of the terminal portions 332b, thereby facilitating the connection between the terminal portions 332b of the discharge electrodes 330 and the signal transmitting member 390.

After sealing the PDP 300, vacuum is exhausted from the PDP 300 and the discharge gas is injected into the PDP 300.

The operation of the PDP 300 will now be described in more detail.

After the manufacturing of the PDP 300 and the injection of the discharge gas are complete, if an address voltage is applied between one of the first discharge electrodes 331 and the third discharge electrodes 333 which serve as scan electrodes and the second discharge electrodes 332 from an external power source, an address discharge is generated. Thus, a discharge cell where a sustain discharge is to be generated is selected from the discharge cells 380.

If a discharge sustain voltage is applied between first discharge electrodes 331 and the third discharge electrodes 333 of the selected discharge cell 380, the sustain discharge is generated due to movement of wall charges accumulated in the barrier rib structure 320 by the first discharge electrodes 331 and the third discharge electrodes 333. The energy level of the discharge gas excited by the sustain discharge is reduced, thereby discharging ultraviolet rays.

The ultraviolet rays excite the phosphor layers 370 in the discharge cells 380. The energy level of the excited phosphor layers 370 is reduced to emit visible light. The emitted visible light passes through the substrate 310 and forms an image to be recognized by a user.

Therefore, the PDP 300 of the present embodiment does not include a rear substrate, which reduces the whole weight and manufacturing costs of the PDP 300.

In the present embodiment, the barrier rib structure 320 and the sealing member 340 of the PDP 300 can be integrally formed, thereby reducing whole manufacturing processes and reducing manufacturing costs.

The PDP 300 of the present embodiment includes the sealing member grooves 360 disposed on the sealing member 340, which prevents the frit 350 from penetrating into the terminal portions of the discharge electrodes 330. Thus the quality of the PDP 300 is improved, and the failure rate of the terminal portions is reduced, thereby reducing manufacturing costs.

The first discharge electrodes 331, the second discharge electrodes 332, and the third discharge electrodes 333 surround the discharge cells 380 so that the sustain discharge is performed at every perimeter position of the discharge cells 380. Therefore, the PDP 300 of the present embodiment has a relatively wide discharge area, thereby increasing light-emitting brightness and light emitting efficiency.

As described above, the PDP of the present invention does not include a rear substrate, thereby reducing weight of the PDP and manufacturing costs thereof.

The PDP of the present invention also forms a frit guide or sealing member grooves in order to prevent a frit from penetrating into terminal portions of discharge electrodes, thereby reducing the failure rate of the terminal portions, which improves quality of the PDP and reducing manufacturing costs thereof.

The PDP of the present invention also integrally forms a barrier rib structure and a sealing member, thereby facilitating overall manufacturing process of the PDP and reducing manufacturing costs thereof.

The PDP of the present invention buries the discharge electrodes in the barrier rib structure to surround discharge cells, so that the PDP has a relatively wide discharge area, thereby increasing light-emitting brightness and light emitting efficiency.

The PDP of the present invention forms a sheet structure, and forms punches on the sheet structure, which makes it possible to form the barrier rib structure and discharge spaces at a time, thereby reducing manufacturing processes of the PDP and manufacturing costs thereof.

While the present invention has been particularly shown and described with reference to exemplary embodiments thereof, it will be understood by those of ordinary skill in the art that various changes in form and details may be made therein without deportioning from the spirit and scope of the present invention as defined by the following claims.

What is claimed is:

1. A plasma display panel comprising:
a substrate;
a barrier rib structure configuring a plurality of discharge cells;
discharge electrodes comprising:
discharge portions arranged inside the barrier rib structure for performing a discharge,
terminal portions arranged on the substrate, and
connection portions connecting the discharge portions with the terminal portions;
a sealing member for sealing the discharge cells;
a frit between the substrate and the sealing member for sealing the substrate and the sealing member;
at least one frit guide between the substrate and the sealing member for restricting a spreading of the frit;
a phosphor layer inside each of the discharge cells; and
a discharge gas sealed in the discharge cells.

2. The plasma display panel of claim 1, wherein a protective layer covers at least a portion of sidewalls of the barrier rib structure.

3. The plasma display panel of claim 1, wherein the discharge portions surround at least a portion of each of the discharge cells.

4. The plasma display panel of claim 1, wherein the discharge portions include a stripe-shaped portion.

5. The plasma display panel of claim 1, wherein conductive wires of a signal transmitting member are connected to the terminal portions.

6. The plasma display panel of claim 1, wherein the sealing member is a dielectric substance.

7. The plasma display panel of claim 1, wherein the sealing member and the barrier rib structure are of a same substance.

8. The plasma display panel of claim 1, wherein the sealing member and the barrier rib structure are integrally formed.

9. The plasma display panel of claim 1, wherein the frit guide is a dielectric substance.

10. The plasma display panel of claim 1, wherein the frit guide and the sealing member are of a same substance.

11. The plasma display panel of claim 1, wherein the frit guide and the sealing member are integrally formed.

12. The plasma display panel of claim 1, wherein the substrate includes phosphor grooves on the substrate and a phosphor on each of the phosphor grooves for forming the phosphor layer.

13. A plasma display panel comprising:
a substrate;
a barrier rib structure configuring a plurality of discharge cells;
discharge electrodes comprising:
discharge portions inside the barrier rib structure for performing a discharge,
terminal portions on the substrate, and
connection portions connecting the discharge portions with the terminal portions;
a sealing member for sealing the discharge cells;
a frit between the substrate and the sealing member for sealing the substrate and the sealing member;
at least one sealing member groove on the sealing member for restricting a spreading of the frit;
a phosphor layer inside each of the discharge cells; and
a discharge gas sealed in the discharge cells.

14. The plasma display panel of claim 13, wherein protective layers cover at least a portion of sidewalls of the barrier rib structure.

15. The plasma display panel of claim 13, wherein the discharge portions surround at least a portion of each of the discharge cells.

16. The plasma display panel of claim 13, wherein the discharge portions include a stripe-shaped portion.

17. The plasma display panel of claim 13, wherein conductive wires of a signal transmitting member are connected to the terminal portions.

18. The plasma display panel of claim 13, wherein the sealing member is a dielectric substance.

19. The plasma display panel of claim 13, wherein the sealing member and the barrier rib structure are of a same substance.

20. The plasma display panel of claim 13, wherein the sealing member and the barrier rib structure are integrally formed.

21. The plasma display panel of claim 13, wherein the sealing member grooves are stripe-shaped.

22. The plasma display panel of claim 13, wherein the sealing member grooves are spaced apart from each other and discontinuously formed.

23. The plasma display panel of claim 13, wherein the substrate includes phosphor grooves on the substrate and a phosphor on each of the phosphor grooves for forming the phosphor layer.
